(19) United States
(12) Patent Application Publication
(10) Pub. No.: US 2013/0139226 A1
(43) Pub. Date: May 30, 2013

(54) Secure Authorization

(71) Applicants: Patrick Welsch, North Andover, MA (US); Wilfried Welsch, North Andover, MA (US)

(72) Inventors: Patrick Welsch, North Andover, MA (US); Wilfried Welsch, North Andover, MA (US)

(21) Appl. No.: 13/688,642

(22) Filed: Nov. 29, 2012

Related U.S. Application Data
(60) Provisional application No. 61/565,277, filed on Nov. 30, 2011.

(51) Int. Cl. G06F 21/30

(52) U.S. Cl. CPC G06F 21/30
USPC 726/4

(57) ABSTRACT

Various embodiments provide an authorization approach that performs a safe and generally untraceable way that allows a user to complete an authorization securely. Various embodiments utilize a visual presentation that displays items, which can include symbols, letters, characters, numbers, logos, pictures, and the like. Throughout authorization, in at least some embodiments, the visual presentation is modified and the locations of items, such as touch-selectable items, are changed such that a pre-defined authorization sequence of items does not have the same serialized pattern of selection for purposes of authorization.

### RELATED APPLICATION

This application claims priority to U.S. Provisional Patent Application No. 61/565,277, filed Nov. 30, 2011, the disclosure of which is incorporated by reference in its entirety.

### BACKGROUND

On computing devices, such as those that utilize touch screens and other authorization mechanisms, a user can leave traces, marks, fingerprints, or heat signatures at the locations touched during authorization. This can include authorization methods such as touching individual locations, or performing swiping a pattern, mouse/touchpad movements or gestures processed by a camera device. Also, it is fairly easy for onlookers of cameras (such as those that might be fraudulently installed at, e.g., ATM's (Automatic Teller Machines), Point of Entry Keypads or Alarm Systems, to observe a user's touch pattern or swipe pattern.

### SUMMARY

Various embodiments provide an authorization approach that performs a safe and generally untraceable way that allows a user to complete an authorization securely. Various embodiments utilize a visual presentation that displays items, which can include symbols, letters, characters, numbers, logos, pictures, colors, portrait pictures from a ‘Contacts’ list, social media applications, photo gallery, pictures from an external database or service that may be locally cached together with textual tag information, and/or shapes which may even be in different sizes or orientations. Throughout authorization, in at least some embodiments, the visual presentation is modified and the locations of items, such as touch-selectable items, are changed such that a pre-defined authorization sequence of items does not have the same serialized pattern of selection for purposes of authorization.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates a grid in accordance with one or more embodiments.

FIG. 3 illustrates a grid in accordance with one or more embodiments.

FIG. 4 illustrates a grid in accordance with one or more embodiments.

FIG. 5 illustrates a grid in accordance with one or more embodiments.

FIG. 6 illustrates a grid in accordance with one or more embodiments.

FIG. 7 illustrates a grid in accordance with one or more embodiments.

FIG. 8 illustrates a grid in accordance with one or more embodiments.

FIG. 9 illustrates a grid in accordance with one or more embodiments.

FIG. 10 illustrates a grid in accordance with one or more embodiments.

FIG. 11 illustrates a grid in accordance with one or more embodiments.

FIG. 12 illustrates a grid in accordance with one or more embodiments.

FIG. 13 illustrates a grid in accordance with one or more embodiments.

FIG. 14 illustrates a grid in accordance with one or more embodiments.

FIG. 15 illustrates a grid in accordance with one or more embodiments.

FIG. 16 illustrates a grid in accordance with one or more embodiments.

FIG. 17 illustrates a grid in accordance with one or more embodiments.

FIG. 18 illustrates a grid in accordance with one or more embodiments.

FIG. 19 illustrates a grid in accordance with one or more embodiments.

FIG. 20 is a flow diagram that describes steps in a method in accordance with one or more embodiments.

### DETAILED DESCRIPTION

### Overview

Various embodiments provide an authorization approach that performs a safe and generally untraceable way that allows a user to complete an authorization securely. Various embodiments utilize a visual presentation that displays items, which can include symbols, letters, characters, numbers, logos, pictures, colors, portrait pictures from a ‘Contacts’ list, social media applications, photo gallery, pictures from an external database or service that may be locally cached together with textual tag information, and/or shapes which may even be in different sizes or orientations. Throughout authorization, in at least some embodiments, the visual presentation is modified and the locations of selectable items, such as touch-selectable items, are changed such that a pre-defined authorization sequence of items does not have the same serialized pattern of selection for purposes of authorization.

The inventive approaches can be utilized with a wide variety of computing devices such as, by way of example and not limitation, mobile devices, desktop devices, keypads, safes that employ authorization technology, construction and industrial equipment, automated teller machines (ATMs), secure Web authorizations or Captchas, devices for performing sobriety checks, vehicle locking/unlocking and starting devices, home, industrial, and/or commercial security bypass mechanisms, to name just a few. With respect to Captchas, the authorization method can display in random order/position, a set of random items and generate instructions to the user like: “Please select the symbols/images in the following order—House—Car—Cloud—Baby—Mountain—Tree—to verify.

The approaches described below are relatively safe because the approaches do not allow for retracing by marks, heat signatures, and/or item locations. The approaches can be personalized to the user. Further, because of the dynamic, changing visual presentation, the authorization sequence can be more difficult to remember or retain for an unauthorized onlooker. Further, the approaches can provide many more authorization possibilities due to the arrangement of items and the manner in which the location or the visual content of items is dynamically changed during the authorization process. For example, tagged images can be pulled from a database and cached locally. This database can be provided as part of a cloud service (e.g., one that supplies content over the Internet). For example, an image of a house may change to a different image of a house, but the tag ‘House’ remains the same.

The various approaches described below can involve item location selection such as, by way of example and not limitation, click-selection, using a pointing device, like mouse or touchpad, press- or touch-selection, sliding selection, or drag and drop action. Items can include, by way of example and not limitation, a sequence of icons, colors, logos, images, numbers, symbols, letters, and/or characters or a combination of various item types. Items may also vary in size.

The visual presentation that is presented to a user can include, by way of example and not limitation, any suitable type of grid, shape, pattern, or randomly scattered items.

An authorization sequence comprises, in one or more embodiments, a plurality of items that make up a larger collection of items. The plurality of items may be selected in a pre-defined order or rank. Alternately or additionally, there may be no pre-defined order or rank such that authorization takes place by selecting, in any suitable order, all of the items that make up the plurality of items within the larger collection of items.

In one or more embodiments, an electronic or computing device or software system generates a random grid or arrangement of items on a screen. The items are displayed as randomized by location throughout the grid. Using a specifically determined sequence or pre-determined sub-collection of items, created by the user during original customization or by downloading content from an external server using the same tag information as defined by the user or authorization provider, the correct screen items are selected, whether in a pre-determined order or not, in order to complete the authorization. Ultimately, at the conclusion of item selection, the user is able to login in or unlock the electronic or computing device and is validated as an authorized user by the device, system software or authorization provider.

Having described an example overview of various embodiments, consider now an example operating environment in which secure authorization can take place.

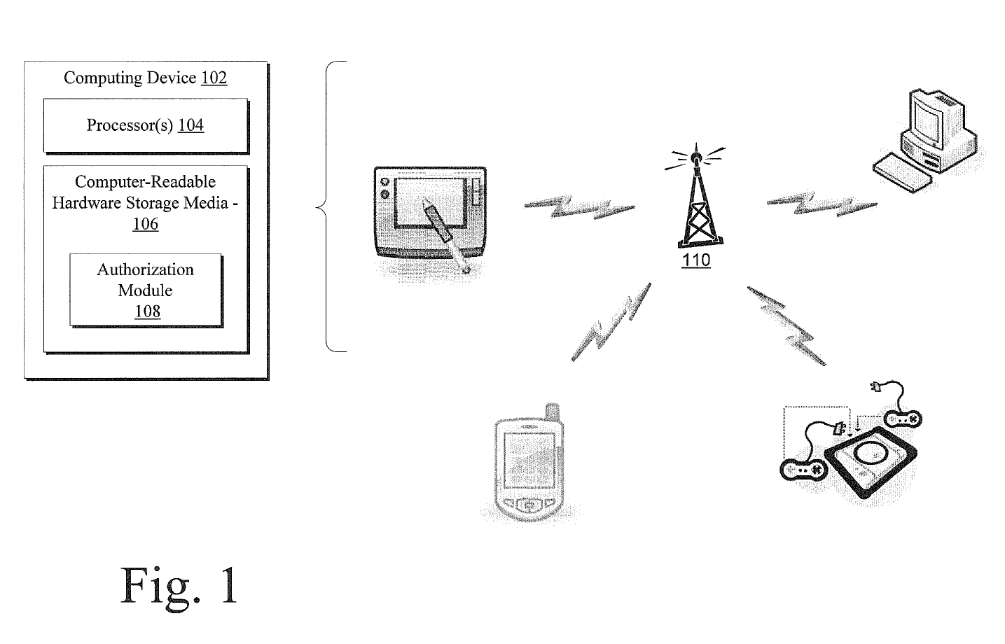

FIG. 1 illustrates an example operating environment in which secure authorization can take place. The operating environment can include at least one computing device, generally illustrated here as computing device 102. Computing device 102 can be any suitable type of computing device, such as a desktop personal computer (PC), a mobile phone apparatus, a gaming console, a tablet PC, a handheld gaming device, a personal digital assistant (PDA) a mobile computing device, and so forth, including those types of devices mentioned above. Thus, computing device 102 can range from computing devices with high complexity resources (e.g. PC), to computing devices with low complexity (e.g. handheld gaming devices). For the purposes of this discussion, computing device 102 is illustrated in FIG. 1 as a slate- or tablet-type device.

Computing device 102 includes one or more processor(s) 104 and one or more computer-readable hardware storage media 106. Processor(s) 104 can be coupled to and/or configured to access computer-readable hardware storage media 106 effective to execute one or more operations. For example, processor(s) 104 can be configured to access a program that includes instructions that perform secure authorization.

Computer-readable hardware storage media 106 represents any suitable type of volatile and non-volatile memory storage device that can be used to store programs, data, and the like. This includes, but is not limited to, Read-Only Memory (ROM), Random Access Memory (RAM), Compact Disc Read-Only Memory (CD-ROM), flash memory, hard disk, removable memory (e.g. Universal Serial Bus (USB) memory sticks), network or Internet connected storage, an authorization provider (e.g., a bank or cloud service such as one offering web services over the Internet) and the like. In some cases, computer-readable hardware storage media 106 or an online storage and authorization provider can be configured to include one or more applications, programs, computer instructions, and the like. Here, computer-readable hardware storage media 106 is illustrated as including an authorization module 108 that performs as described above and below. The authorization module 108 can be provided through an online service and/or through an authorization provider.

FIG. 1 illustrates various types of computing devices connecting wirelessly to one another through an access point or other form of wireless networking, shown generally here at 110. Connection can occur wirelessly or through a wired connection. The access point can comprise any suitable type of network or access point such as the Internet or a wirelessly enable access point. This example is representative of an ability for one or more computing devices to connect with one another. It is to be appreciated that any suitable type of network and/or connection can be used by different computing devices to connect and/or communicate with one another, e.g., mesh networking and the like. Alternately or additionally, different types of devices can be connected to one another. Any or all of the illustrated devices can utilize the authorization techniques described herein.

### Example Embodiments

In the embodiments described below, various different approaches are described. First, a section entitled “Pressing Method” describes an approach in which individual displayed items are pressed, touched or selected, either through a touch-engagement as by a user's finger, through the use of a suitably-configured stylus or other pointing device, like a mouse or touchpad, or any other means with a computing device such as a natural user interface that recognizes movements and other gestures. Next, a section entitled “Sliding Method” describes an approach in which displayed items are selected through a sliding gesture which defines a pattern as between the selectable items. Following this, a section Entitled “Ultra Safe Method” describes an embodiment that adds a dynamic aspect in which the visual presentation is modified throughout the authorization process. Next, a section entitled “Home Screen Lock Screen Method” describes authorization that takes place relative to a so-called home screen. Finally, a section entitled “Drag and Drop Method” describes an authorization that takes place using drag-and-drop functionality.

Pressing Method

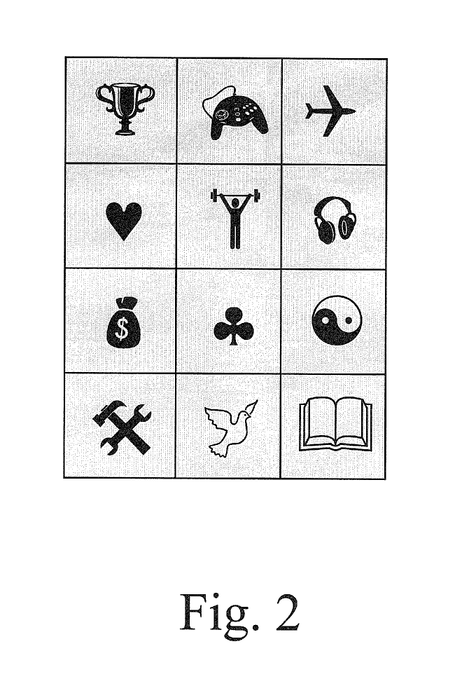

FIG. 2 illustrates an example grid in accordance with one or more embodiments. The grid includes a collection of items a plurality of which constitutes a subset that is used for authorization.

The user is first presented with the grid. In this example, there is a hidden item sequence that only the user knows. To complete authorization, the user selects the correct items in order to enable the authorization and complete the sequence. Selection in an authorization pattern can occur through a pressing input, as by a user pressing, touching or selecting items, either through a touch-engagement as by a user's finger, through the use of a suitably-configured stylus or other pointing device, like a mouse or touchpad, or any other means with a computing device such as a natural user interface that recognizes movements and other gestures.

Every time the user needs to reenter the sequence, the grid or item presentation can, but need not necessarily, change and rearrange itself and the items will be relocated randomly. However the sequence is still the same, but this time the items have different locations. Items can be rearranged in ways such as a grid, shapes, or scattered randomly. In this example the authorization presentation remains consistent as a grid and the sequence is order specific.

Let's say the user has this sequence or code for their authorization key:

[symbol]

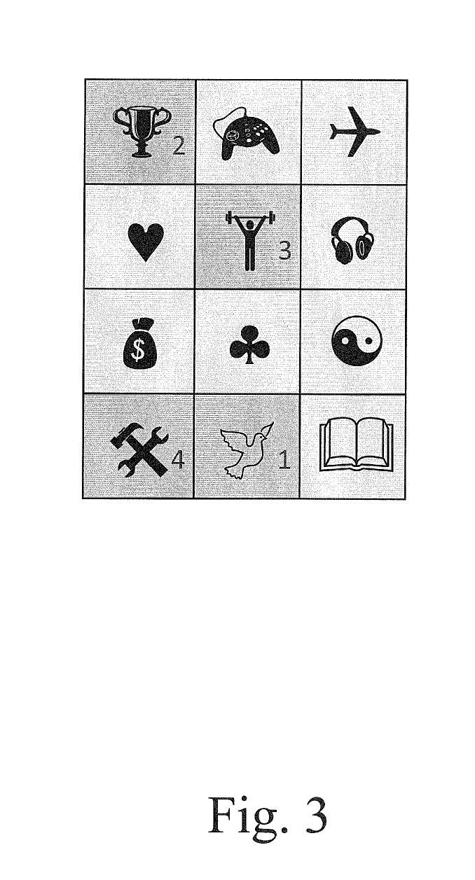

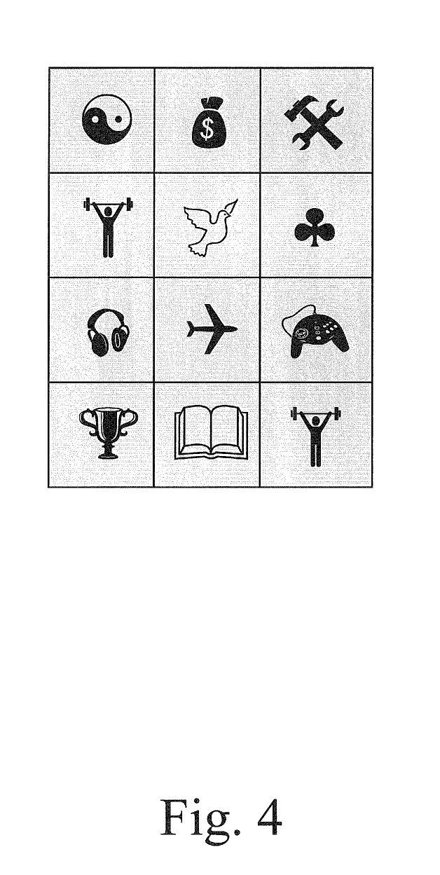

FIG. 3 illustrates the correct authorization sequence with each item numbered in sequence of the selection. Assume that the user has authorized to the system and completed their transaction. The next time the user attempts to be authorized to the system, a different arrangement of the items can be utilized. As an example, consider FIG. 4.

Here, the same items are utilized except that the items appear in a different order within the grid.

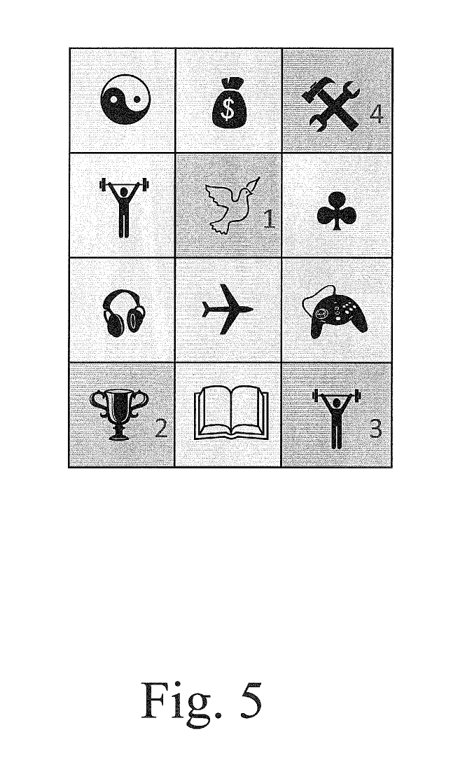

FIG. 5 illustrates the correct authorization sequence with each item numbered in sequence of the selection. Notice, in this example, the second attempt or reentry item selection is the same, except for the locations of the enumerated items. The user now uses the same sequence to perform the authorization but the items are now in different locations.

Sliding Method

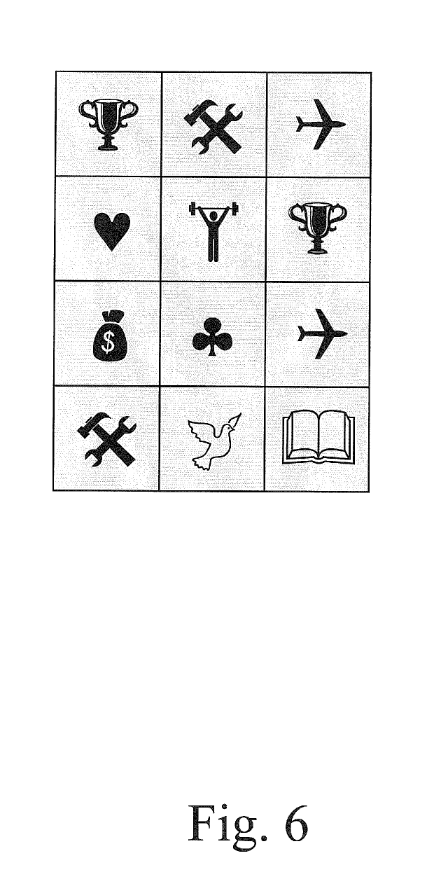

FIG. 6 illustrates an example grid in accordance with one or more embodiments. The grid includes a collection of items a plurality of which constitutes a subset that is used for authorization.

The sliding method utilizes the same concept as above, except instead of a pressing input, e.g., touch-selecting the items individually, the items are generated in a way where the user is able to draw a pattern and connect the items, by way of a sliding input, similar to “connecting the dots”. Note that in this example, the authorization presentation remains consistent as a grid and the sequence is order specific.

Assume that the user has this item sequence for their authorization key:

[symbol]

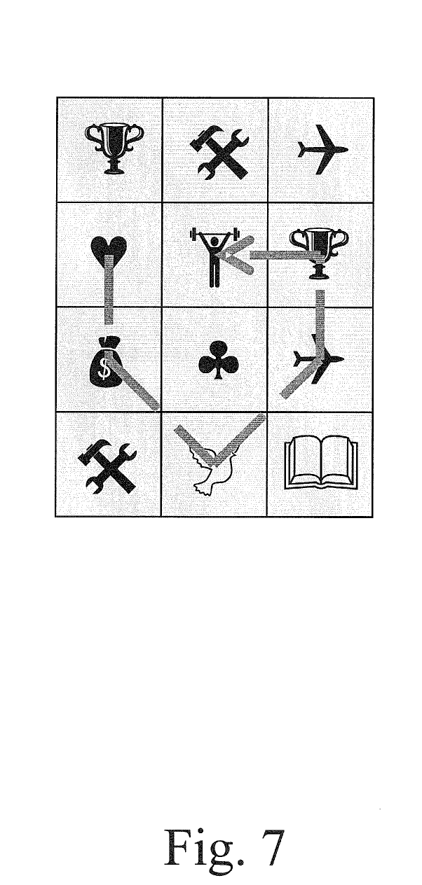

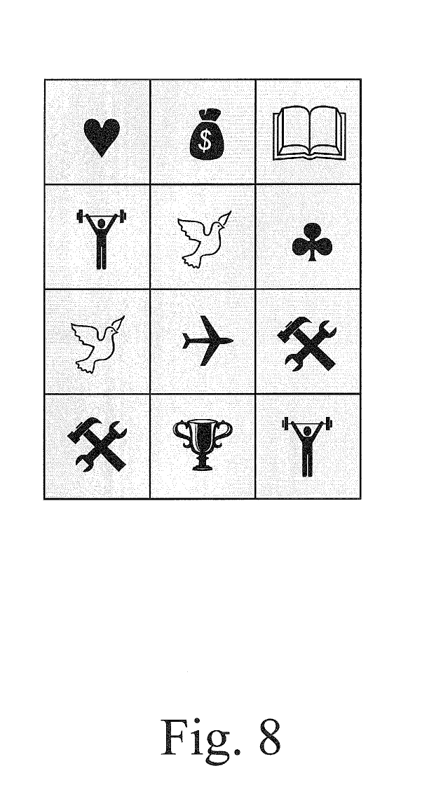

FIG. 7 shows the user's sliding authorization pattern that connects the individual items in their authorization key. Assume that the user has authorized to the system and completed their transaction. The next time the user attempts to be authorized to the system, a different arrangement of the items can be utilized. As an example, consider FIG. 8.

Here, the same items are utilized except that the items appear in a different order within the grid.

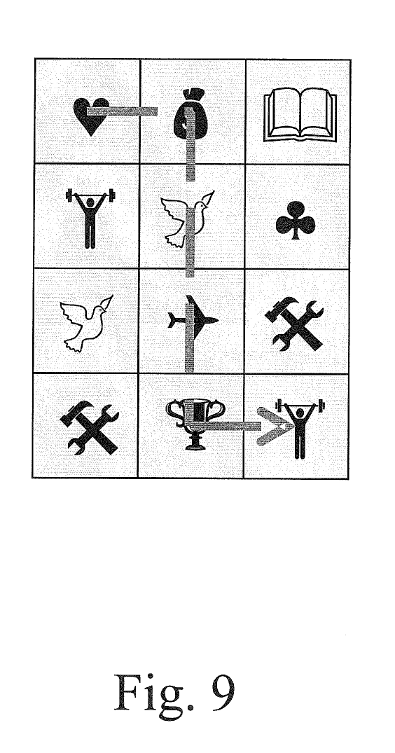

FIG. 9 shows the user's sliding authorization pattern that connects the individual items in their authorization key. Notice that the items in the authorization key and their particular order remain the same. However, the authorization pattern is different because the items have been relocated within the grid.

Ultra Safe Method

Using the ultra safe method, the grid is regenerated after selecting each item, regardless of whether the selection is right or wrong. The device unlocks when the sequence or authorization pattern has been completed correctly from beginning to start. If the user enters a wrong item, it generates a new grid, with or without the correct following item. To reset the item submissions the user can shut off the screen and turn it on, on such devices like a smartphone. The user may also be presented with buttons like “reset” and “finish” with smartphones or other devices.

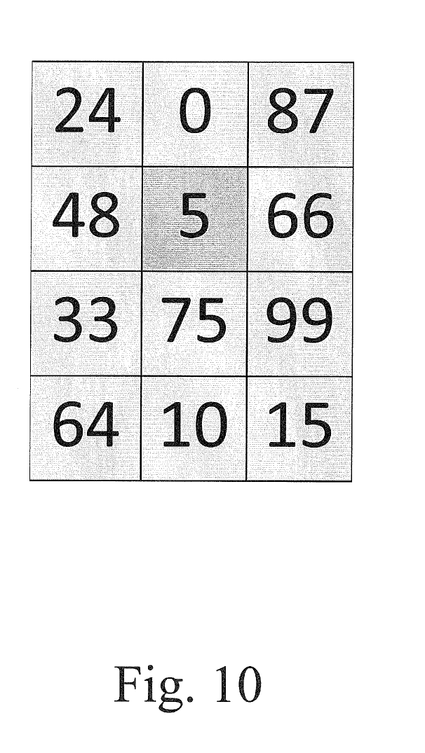

Note that each regeneration may take forms in different authorization presentations, from grids, shapes, patterns, or random scattered. In this example, the authorization presentation remains consistent as a grid and the sequence is order specific. The items are numbers and range from 1-100. In this example, the user uses this set of numbers for their sequence: 5, 82, 69, 13, 7. As an example, consider FIG. 10.

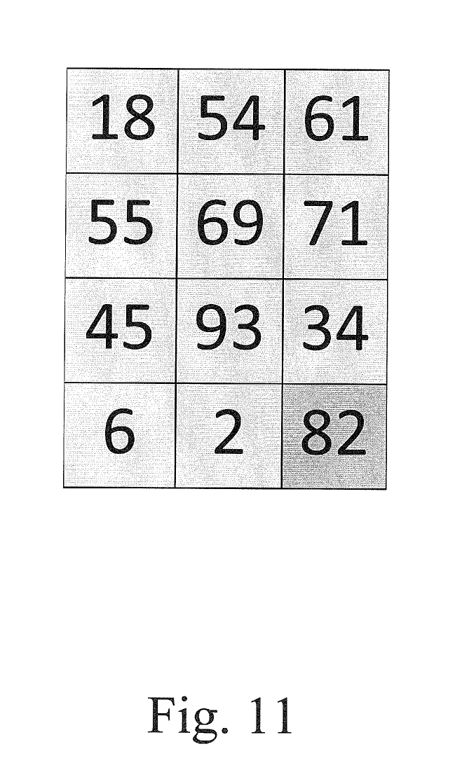

Assume that the user has hit the first item in the sequence, 5, which is correct. After selecting the item, the authorization method will now regenerate a new grid with a different set of items so that the user can enter the next item in the sequence. As an example, consider FIG. 11.

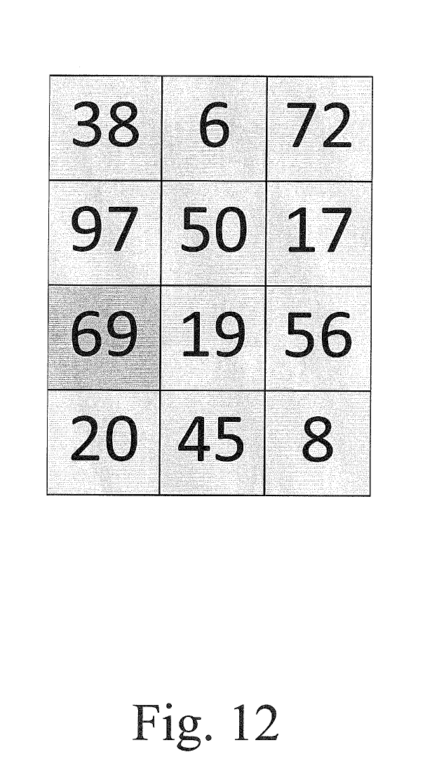

There, the user has hit the second item in the sequence, 82, which is correct. After entering the item, the authorization method will now regenerate a new grid with a different set of items so that the user can enter the next item in the sequence. As an example, consider FIG. 12.

There, the user has hit the third item in the sequence, 69, which is correct. After entering the item, the authorization method will now regenerate a new grid with a different set of items so that the user can enter the next item in the sequence.

The user can then go on to select 13 and, after regeneration of the grid, 7, to complete authorization. Now that the user entered the sequence correctly, the authorization has now been completed. In addition, a finish or enter button can be presented to submit the correct sequence to indicate when the sequence ends.

Assume now that the user's authorization sequence is: 13, 34, 96, 2, and 71.

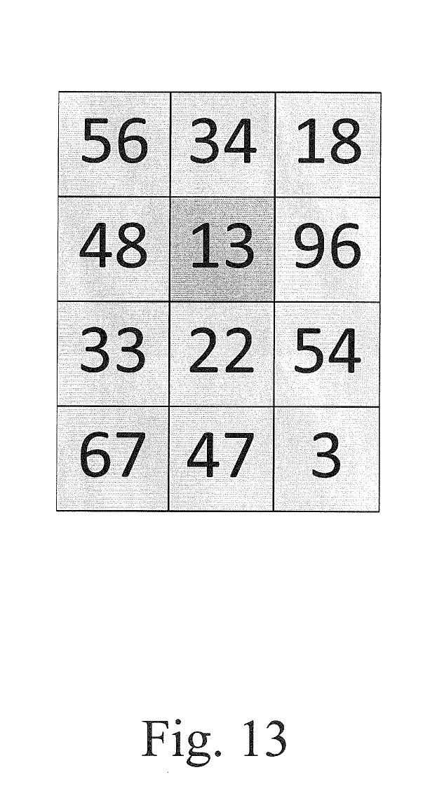

As an example, consider FIG. 13 which illustrates another grid accordance with one or more embodiments. Suppose the user enters the first and second items correctly and the third one incorrectly. The authorization method will continue to regenerate item sets. Since the user has entered the wrong item, the authorization method keeps on regenerating grids every time the user hits any of the items. This way the user (if not the owner of the sequence) will never know how many and which items there are to complete the sequence.

Home Screen Lock Screen Method

In one or more embodiments, authorization can take place using a so-called home screen. The home screen authorization method utilizes the icons of the applications, widgets, images, or anything configured to be displayed on the homepage(s) or the home screen as the lock screen. In these examples, the home screen method is utilized using the Windows 8 and Apple iOS home screens. The sequence is also order specific.

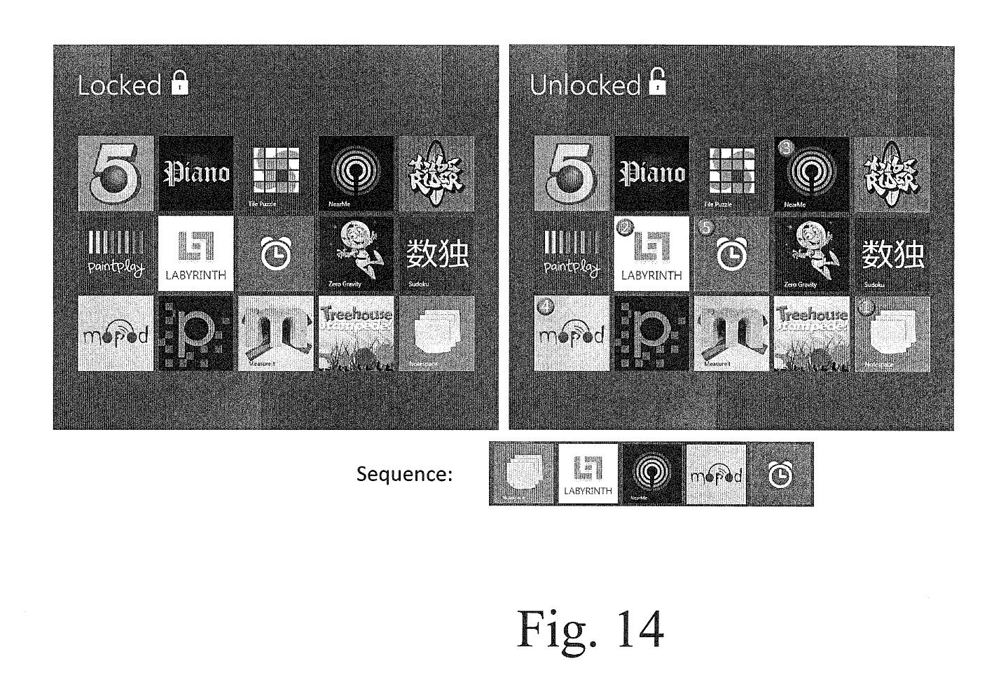

As an example, consider FIG. 14 which illustrates, in the leftmost portion of the figure, a locked home screen. The authorization sequence is shown at the bottom and the input authorization pattern is shown in the rightmost portion of the figure indicated by the numerals.

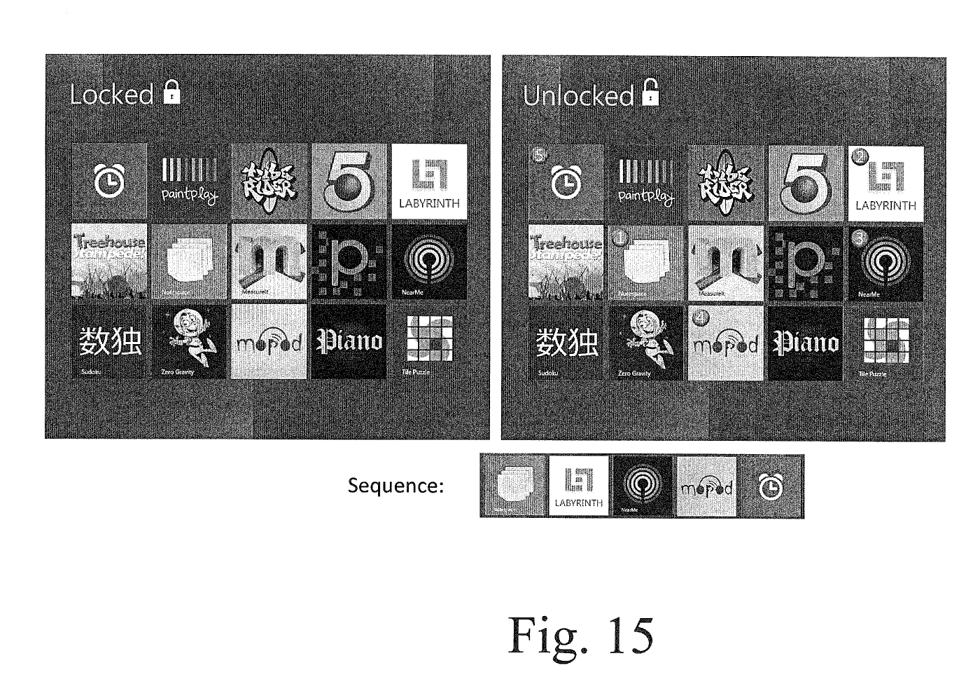

FIG. 15 illustrates the homescreen on a subsequent authorization attempt. Notice the icons have been re-arranged, but the authorization pattern remains the same.

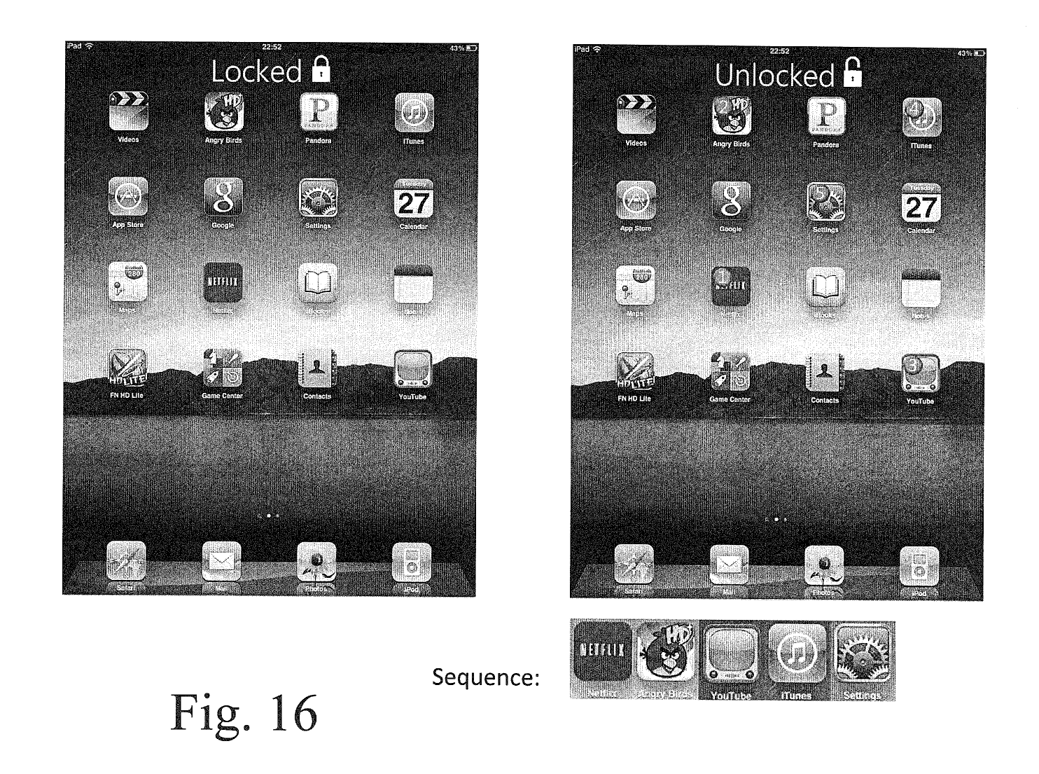

As another example, consider FIG. 16 which illustrates, in the leftmost portion of the figure, a locked home screen. The authorization sequence is shown at the bottom and the input authorization pattern is shown in the rightmost portion of the figure indicated by the numerals.

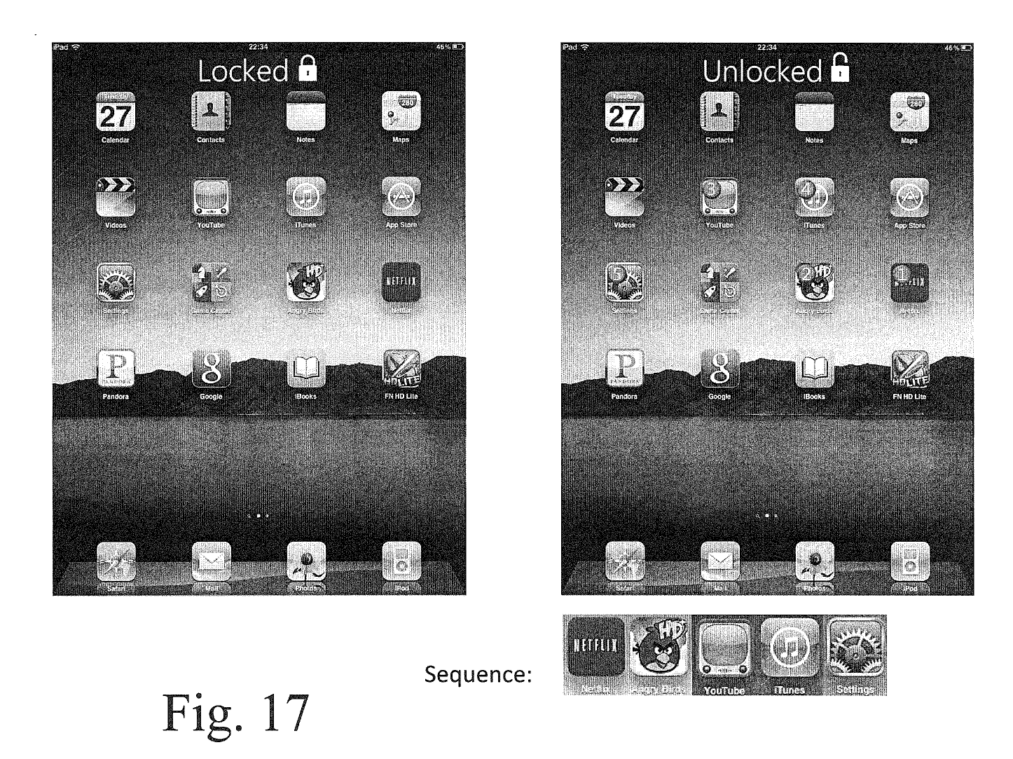

FIG. 17 illustrates the homescreen on a subsequent authorization attempt. Notice the icons have been re-arranged, but the authorization pattern remains the same.

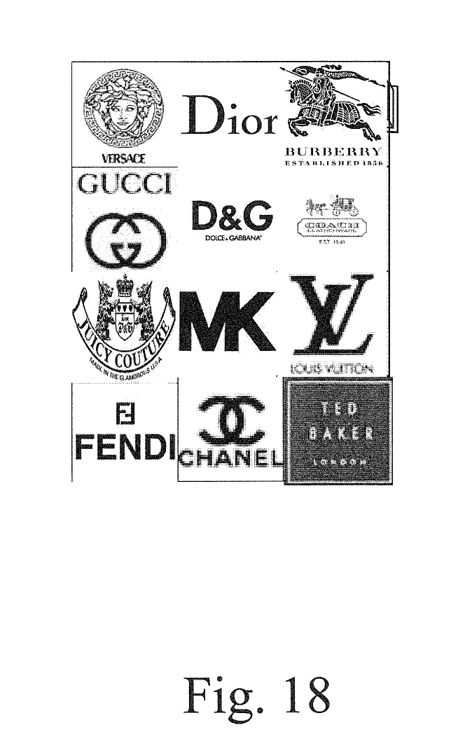

In some embodiments, different items can be used to add a degree of personalization to the authorization process. As an example, consider FIG. 18

Here, there is the possibility for using different user-selected themes including, by way of example and not limitation, different images, icons, or logos from companies or businesses. Here, a female user has chosen her icon set to include designer logos for her “Designer Theme” to personalize her device.

Drag and Drop Method

In one or more embodiments, authorization can take place using a drag and drop method. For example, on mobile devices, especially touch screen devices, typing captchas with a touch screen keyboard becomes difficult, inefficient, and hard to read. Using a drag and drop method that permits dragging and dropping of images or objects is more efficient and it becomes much easier to see, versus trying to type out letters that may be difficult to see. On touch screens, it is easy to touch to select and drag the object over to the correct place to give input to the sequence for authorization. This method can also be used for secure authorization. Thus, the authorization pattern can be defined through drag and drop operations.

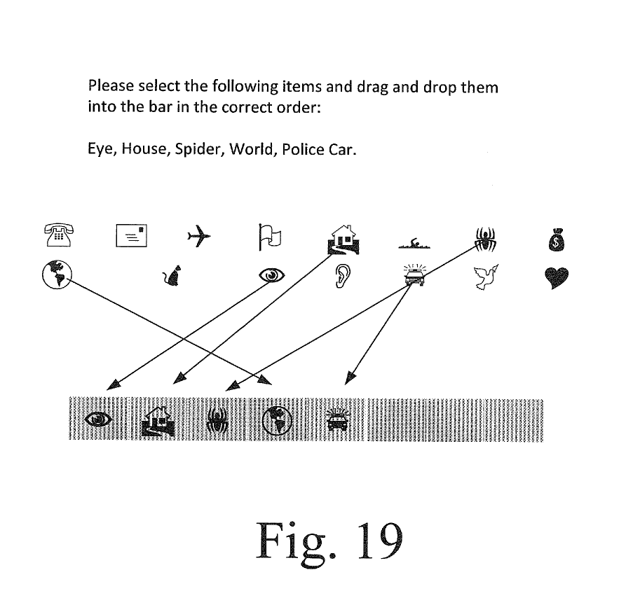

As an example, consider FIG. 19. There, the user is prompted with text to “Please select the following items and drag and drop them in the correct order: Eye, House, Spider, World, Police Car.” Correspondingly, the user can select the appropriate item and drag and drop it into the correct placement on a displayed template.

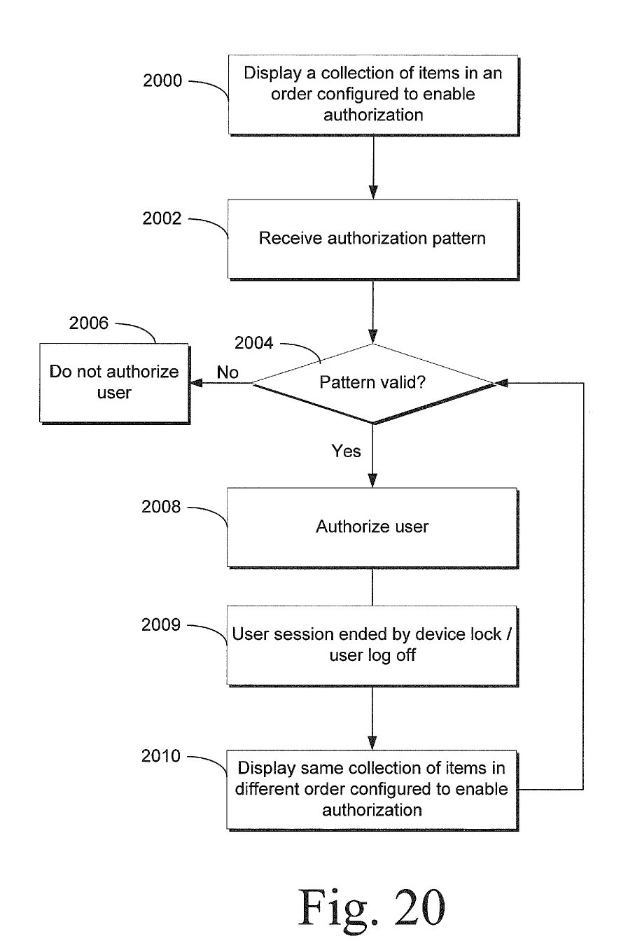

FIG. 20 is a flow diagram that describes steps in a method in accordance with one or more embodiments. The method can be implemented in connection with any suitable hardware, software, firmware, or combination thereof. In at least some embodiments the method can be implemented by a suitably-configured authorization module, such as authorization module 108 in FIG. 1.

Step 2000 displays a collection of items in an order configured to enable authorization. Examples of how this can be done are described above. In at least some embodiments, the collection of items can be received from a local source, such as a local client device. Alternately or additionally, the collection of items can be received from a remote source such as a cloud or web service, remote image database, and/or an authorization provider that provides images or symbols that provide different representations for the same or similar textual tags, to name just a few. Other sources of the collection of images can include, by way of example and not limitation, social networking applications, photo galleries, camera rolls, and the like.

Step 2002 receives an authorization pattern. This step can be performed in any suitable way, examples of which are provided above. Step 2004 ascertains whether the authorization pattern is valid. If the authorization pattern is not valid, step 2006 does not authorize an associated user. If, on the other hand, the authorization pattern is valid, step 2008 authorizes the user. Step 2009 ends a particular user session by, for example, a device lock or user log off. When the user attempts to log back on, step 2010 displays the same or a similar collection of items in a different order configured to enable authorization. The method then returns to step 2004 to complete the authorization process.

In addition to the techniques described above, other approaches can be utilized without departing from the spirit and scope of the claimed subject matter. For example, a user can be presented with images and/or symbols from a pre-defined set of images or symbols one at a time, together with the question “Do you recognize this image?” The images or symbols can be those with which a user is familiar, e.g. personal pictures, images, and the like, as well as those with which a user is unfamiliar. After a predetermined number of correct answers, the user may be authorized.

In addition, in alternate embodiments, the positions of the symbols or images may not necessarily be randomized. In these embodiments, the positions would remain the same.

### CONCLUSION

Various embodiments provide an authorization approach that performs a safe and generally untraceable way that allows a user to complete an authorization securely. Various embodiments utilize a visual presentation that displays items, which can include symbols, letters, characters, numbers, logos, pictures, colors, portrait pictures from a ‘Contacts’ list, and/or shapes which may even be in different sizes or orientations. Throughout authorization, in at least some embodiments, the visual presentation is modified and the locations of items, such as selectable items, are changed such that a pre-defined authorization sequence of items does not have the same serialized pattern of selection for purposes of authorization.

1. A method comprising:
displaying a collection of items in order configured to enable authorization;
receiving an authorization pattern;
ascertaining whether the authorization pattern is valid;
responsive to the authorization pattern being valid, authorizing an associated user;
displaying the same or a similar collection of items in a different order configured to enable authorization;
receiving an authorization pattern relative to the same or similar collection of items;
ascertaining whether the authorization pattern relative to the same or similar collection of items is valid; and
responsive to the authorization pattern relative to the same or similar collection of items being valid, authorizing the associated user.

2. The method of claim 1, wherein the authorization patterns are defined by receiving a pressing input.

3. The method of claim 1, wherein the authorization patterns are defined by receiving a sliding input.

4. The method of claim 1, wherein the authorization patterns are defined through drag and drop operations.

5. The method of claim 1, wherein the items comprise images.

6. The method of claim 1, wherein the items comprise numbers.

7. The method of claim 1, wherein the items comprise icons comprising part of a home screen.

8. The method of claim 1, wherein the items comprise user selected themes.

9. The method of claim 1, wherein receiving the authorization pattern comprises:
receiving an item selection;
responsive to receiving the item selection, regenerating display of the collection of items in a different order; and
receiving at least one additional item selection.

10. The method of claim 9, wherein the items comprise numbers.

11. The method of claim 1, wherein receiving the authorization pattern comprises:
receiving an item selection;
responsive to receiving the item selection, regenerating display of the collection of items in a different order regardless of whether the item selection is correct; and
receiving at least one additional item selection.

12. The method of claim 11, wherein the items comprise numbers.

13. One or more computer-readable hardware storage media embodying computer readable instructions which, when executed, implement a method comprising:
displaying a collection of items in an order configured to enable authorization;
receiving an authorization pattern;
ascertaining whether the authorization pattern is valid;
responsive to the authorization pattern being valid, authorizing an associated user;
displaying the same or a similar collection of items in a different order configured to enable authorization;
receiving an authorization pattern relative to the same or similar collection of items;
ascertaining whether the authorization pattern relative to the same or similar collection of items is valid; and
responsive to the authorization pattern relative to the same or similar collection of items being valid, authorizing the associated user.

14. The one or more computer-readable hardware storage media of claim 13, wherein the authorization patterns are defined by one of: receiving a pressing input, receiving a sliding input, or through drag and drop operations.

15. The one or more computer-readable hardware storage media of claim 13, wherein the items comprise images.

16. The one or more computer-readable hardware storage media of claim 13, wherein the items comprise numbers.

17. The one or more computer-readable hardware storage media of claim 13, wherein the items comprise icons comprising part of a home screen.

18. The one or more computer-readable hardware storage media of claim 13, wherein receiving the authorization pattern comprises:
receiving an item selection;
responsive to receiving the item selection, regenerating display of the collection of items in a different order; and
receiving at least one additional item selection.

19. The one or more computer-readable hardware storage media of claim 18, wherein the items comprise numbers.

20. The one or more computer-readable hardware storage media of claim 13, wherein receiving the authorization pattern comprises:
receiving an item selection;
responsive to receiving the item selection, regenerating display of the collection of items in a different order regardless of whether the item selection is correct; and
receiving at least one additional item selection.
